(19) United States
(12) Patent Application Publication
(10) Pub. No.: US 2007/0085361 A1
(43) Pub. Date: Apr. 19, 2007

(54) Injection molded parts for vehicles and other devices

(76) Inventor: Christian Hauser, Berryville, VA (US)

Correspondence Address: Richard S. Meyer;McGuireWoods LLP, Suite 1800, Tysons Corner, 1750 Tysons Boulevard, McLean, VA, 22101-4215, US

(21) Appl. No.: 11/582,428

(22) Filed: Oct. 18, 2006

Related U.S. Application Data
(60) Provisional application No. 60/727,840, filed on Oct. 19, 2005.

(51) Int. Cl. B60R 13/02

(52) U.S. Cl. 296/1.08

(57) ABSTRACT

A vehicle part such as a body molding includes a trim piece connected to a bearer piece by a flexible and foldable hinge, which is preferably integrally molded with the trim and bearer pieces in a single injection mold. The trim piece and bearer piece are folded about the molded hinge to rotate towards each other and are snap-fitted together to form an integral body side molding that can be adhesively and/or clippedly affixed to a support surface, such as a vehicle body side panel. Methods for manufacturing and installing such vehicle parts are also disclosed.

### CROSS REFERENCE TO RELATED APPLICATION

This application claims priority under 35 U.S.C. §119(e) to U.S. Provisional Patent Application No. 60/727,840, filed on Oct. 19, 2005, the disclosure of which is expressly incorporated by reference herein in its entirety.

### BACKGROUND OF THE INVENTION

1. Field of the Invention

The invention relates generally to injection molded parts and, more particularly, to molded parts particularly suited for use as body side moldings for vehicles and other automotive parts.

2. Background Description

Various types of molded parts are commonly used on cars, trucks and other types of motor sport or recreational vehicles to produce vehicle designs that are visually appealing and/or prevent damage to the vehicle finish, or for other known purposes. In particular, body moldings, claddings, and rocker panels are typically molded plastic parts, usually elongate in shape, that are affixed to the exterior surface of a door, quarter panel, or other body part, which is typically made of sheet metal. An automotive body side molding is typically mounted to a vehicle using a mechanical connection such as plastic clips and/or double-sided adhesive tape. In one known design, the plastic clips are of the type having a base portion that attaches to a receptacle formed on an inner surface of the molding, and a protruding portion that lockably inserts within a corresponding receptacle formed in the sheet metal or other material that forms a vehicle body part. FIG. 1 shows an example of automotive body side moldings 100 in position on side panels 105 and 110 of a vehicle 115.

Although use of clips often provides sufficient structural support for the body molding, there are disadvantages to such an attachment. For example, a gap typically appears between the top edge of the body molding and the surface of the vehicle body part to which it is attached. The gap results from the plastic clips being attached to the body side molding at positions distal from its edges. To create a more visually appealing appearance, and/or provide a more watertight attachment, a strip of double-sided tape has been placed along the top edge of the body molding before it is snapped into place. The double-sided tape, which is either a long thin straight length of tape or one or more shaped die-cuts of tape, fills the gap between the top edge of the body molding and the surface of the vehicle body part. In most instances, tape is not applied to the bottom edge of the body molding because this bottom edge is not typically visible to a person viewing the vehicle. However, attachment designs using two rows of adhesive tape, and no clips, are also known.

Various molding processes known to persons of ordinary skill in the art have been used to mold plastic parts suitable for use as such body moldings, although injection molding is typically used for reasons discussed herein. Ideally, the plastic part should have a solid area to which the tape is applied on the back or non-visual side of the component. However, unless relatively thick sidewalls are used, injection molding such parts with thickened tape attachment surfaces provides sink marks that outline the relatively thick solid tape attachment area on the side of the part that is visible when the body side molding is attached to a vehicle body part. (The visible side may be referred to as the “A” surface.) The sink marks are caused by readthrough, which is a known phenomenon that occurs when a molded plastic part has solid areas of substantially different thickness. Readthroughs occur with different polymers at varying degrees. All polypropylene materials (thermoplastic polyolefins (TPO), thermoplastic elastomers (TPE), polypropylene (PP), elastomer modified polypropylene (EMP), etc.), polyvinyl chloride (PVC), polyethylene (PE), acrylonitrate-butadiene-styrene (ABS), and many other materials are prone to readthroughs, which are caused by thicker areas from ribs and bosses.

The degree of readthroughs is also dependent on the percentage and kind of filler in a given polymer. Typically, body moldings are not cast in a uniform thickness throughout to reduce the weight of the finished product as well as its manufacturing cost. Thus, for example, if a body molding were cast to include a hollow interior area and a solid strip along an inside top edge thereof for receiving a piece of double-sided tape, one or more outlines of the solid strip or sink marks would “read through” and become visible on the “A” surface. Thus, the “A” surface would be marred by the outlines of underlying support structures. Prior to the invention, the best way to avoid readthroughs was to avoid molding any ribs, bosses, clip pockets, or other structures, which cause a significant discontinuity in the thickness of the molded part. Thus to prevent readthrough in body side moldings, the tape adhesion area conventionally has been formed of a series of thin, substantially parallel ribs, each separated by a small gap.

FIG. 2 is a cross-sectional view of a conventional one-piece body side molding 200 illustrating the concave shape defined by an “A” surface 215 and a rear surface 220. The “A” surface is an outer surface of the conventional body molding 200 that is visible when the conventional body molding 200 is attached to a support surface 205, such as, but not limited to, a body part of a vehicle. The rear surface 220 includes an adhesion area 210 formed along at least a top back edge and/or a bottom back edge of the body side molding 200. One or more brackets 225 formed on the rear surface 220 facilitate lifting, drying, and/or painting of the body side molding 200.

The body side molding 200 may be attached to a support surface 205 using an adhesive material, a clip (not shown), or a combination thereof. For example, a strip of adhesive material 230 (typically, double-sided tape) may be applied at least to an adhesion area 210 to affix the body side molding 200 to a support surface 205. At a minimum, the adhesive material 230 is applied to the adhesion area 210 (formed along the top back edge of the conventional body side molding 200) to create a visually pleasing appearance and a more watertight connection in use. In this particular design, no tape is applied along the bottom edge 245 of the body side molding 200.

The gripping force of the adhesive material 230 is generally proportional to the surface area of the adhesion area. This, combined with the overall weight of the body side molding 200, the intended application (off-road use or highway use, etc.), and other factors, will drive the amount of adhesive material needed for a particular application. Thus, the type of adhesive material, the number, size, spacing, orientation, and location of the adhesion area (or areas) 210 will vary for each particular application. However, such parameters have been easily determined by persons of ordinary skill in the art using known design considerations.

In addition to the one-piece body side moldings described above, two-piece and multi-piece body side moldings have also been contemplated. Examples of such two-piece and multi-piece body side moldings are shown in U.S. Pat. Nos. 6,318,045, 5,639,522, 5,183,303, and 4,666,196. The individual pieces of such moldings, however, are typically formed separately and then assembled using methods that vary depending on the end-application and the material(s) used to form one or both pieces. For example, the individual body side molding pieces have been typically welded, glued, taped, or clipped together.

Applicant discovered various problems with conventional two-piece designs. For example, conventional two-piece designs typically have relatively thick sidewalls. The thick sidewalls increase the overall weight of the body side molding and lengthen cooling times in an injection molding process. The increased weight requires extra fasteners and/or adhesive. Additionally, multiple molds and/or multiple mold actions per mold are typically required to form the individual pieces. Thus, multi-pierce moldings therefore are typically more expensive to make and more labor-intensive to use than single piece moldings.

Further, numerous extrusion molded parts for various applications including for use in vehicles have been proposed, such as described in U.S. Pat. Nos. 6,205,741, 5,743,24, 5,409,746, 5,014,486, 4,401,701, 4,308,704, and 2,910,033. The drawbacks, however, associated with using extrusion molding are that extrusion molded parts require further processing to obtain clean and ready to use moldings. For example, other parts such as end caps are often required to obtain smooth edges on extrusion molded parts, thus further complicating the manufacturing process and increasing costs.

The foregoing demonstrates needs for an improved vehicle molding and a simplified molding process for making the vehicle molding or similar parts that provides a clean and ready to use lightweight molding having no readthroughs and that may be lighter in weight and more easily manufactured, assembled, and/or customized than heretofore accomplished.

### SUMMARY OF THE INVENTION

The invention meets the foregoing needs and avoids the drawbacks and disadvantages of the prior art by providing an injection molded vehicle molding made by injection molding or similar processes that produce a clean, ready to use part that does not require further processing steps before use, except, of course, for washing, drying, painting or other finishing steps. The injection molded vehicle molding of the invention includes a decorative portion, a support portion, and an integral hinge connected therebetween. The support portion is movable between a first open position and a second closed position in which the support portion is fitted within an interior portion of the decorative portion. The decorative and support portions may be molded with features providing a snap fitting connecting the two portions together in the closed position. A vehicle molding constructed according to the principles of the invention may be adhesively and/or clippedly affixed to a support surface, such as a vehicle body side panel. Methods of making and installing the molding of the invention are also disclosed. The invention may be implemented in various ways.

According to one aspect of the invention, a vehicle molding for protecting a surface of a vehicle includes a unitary injection molded piece having a decorative portion, a support portion, and a hinge disposed therebetween. The hinge may have a thickness less than the thickness of at least one of the decorative and support portions to facilitate pivotal motion of the decorative and support portions relative to each other from a first expanded position in which the decorative and supportive portions are spaced apart to a second collapsed position in which the decorative and support portions are adjacent to each other. The decorative portion may be of relatively uniform thickness and have a decorative surface substantially free of readthrough. An attachment mechanism connects the decorative and support portions together in the collapsed position. A portion of the decorative portion may include a first part and a portion of the support portion may include a second part that engages with the first part to form the attachment mechanism. The first and second parts may be integrally molded with the decorative and support portions. For example, the first part may be a ridge and the second part a lip engageable with the ridge to form a snap connection. The decorative portion may have a first shape and the support portion a second shape that matingly corresponds to the first shape when the decorative portion and the support portion are in the collapsed position secured together by the attachment mechanism. One of the first and second shapes may be convex, and the other may be concave such that the decorative portion and the support portion are nested together in the collapsed position. The support portion may include at least one engagement member integrally formed therewith to connect the molding to the surface of the vehicle. At least one tension rib may be disposed between and contact the decorative portion and the support portion in the collapsed position. The tension rib may be integrally formed with one of the decorative portion and support portion from a thin piece of deformable plastic. The support portion may also include at least one insert and the decorative portion may include at least one opening such that the at least one insert fits through the at least one opening when the decorative portion and the support portion are in the collapsed position. The insert may include at least one of extruded plastic, chromed metal inserts, company logos, illuminated decals, and light emitting diodes and be attached to the support portion by at least one of friction, double-sided tape, and glue. The support portion may further include at least one cutout. The support portion may also include at least one substantially flat surface so that tape and/or an adhesive may be applied to connect the molding to the surface of the vehicle. The decorative portion and the support portion may have a thickness of about 1.8 mm to about 2.5 mm. The molding may be a body molding to protect an outer surface of the vehicle. It may be attached to one of a cladding near the rear door license plate illumination strips, cowl, incorporating seal, spray nozzle body, capturing hose assembly, radiator grill, pillar cover, rocker panel, seat assembly cover, side panel, interior organizer, and door panel of a vehicle.

According to another aspect of the invention, a method of making a vehicle molding having a decorative portion and a support portion connected by a hinge using injection molding includes: providing a single mold to form the decorative portion, the support portion, and the hinge; filling the mold with a moldable material; integrally injection molding the decorative portion, the support portion, and the hinge in the single mold from the moldable material such that the hinge has a thickness less than the thickness of at least one of the decorative and support portions to facilitate pivotal motion of the decorative and support portions and the decorative portion is substantially free of readthrough; curing the moldable material; and removing the molding from the mold. The method may further include the step of integrally forming one or more engagement members on the support portion during the injection molding step. The method may further include the step of integrally forming one or more tension ribs on at least one of the support portion and the decorative portion, such that the tension ribs are disposable between and may contact the support and decorative portions during use. The method may further include the step of forming one or more openings in one of the decorative portion and the support portion and inserting one or more decorative or functional members through the one or more openings. The injection molding step may include forming at least one film gate on at least one of the support portion and the hinge. The injection molding step may include one or more of compression injection molding, gas assist injection molding, water assist injection molding, gas counter-pressure injection molding, and reaction injection molding (RIM). The molding material may include one or more materials including, but not limited to thermoplastic polyolefins, acrylonitrate-butadiene-styrene, polycarbonate, polybutadiene terephthalate, polyethylene terephthalate, nylon, polyvinyl chloride, polystyrene, polypropylene, polyethylene, thermoplastic polyolefin, synthetic rubber, glass, or blends thereof. In this method at least one of the decorative portion and the support portion may have a thickness of between about 1.8 mm to about 2.5 mm. The method may further include one or more finishing steps of washing, drying, and painting at least one of the decorative portion, the support portion, and the hinge.

According to yet another aspect of the invention, a method of attaching a molding to a surface of a vehicle includes: providing a unitary injection molded part having a decorative portion and a support portion connected by a hinge having a thickness less than the thickness of at least one of the decorative and support portions to facilitate pivotal motion of the decorative and support portions relative to each other from a first expanded position in which the decorative and supportive portions are spaced apart to a second collapsed position in which the decorative and support portions are adjacent to each other, with the decorative portion being of relatively uniform thickness and having a decorative surface substantially free of readthrough, the support portion including engagement members to connect the molding to the surface of the vehicle, and attachment mechanism to connect the decorative and support portions together in the collapsed position; positioning the decorative portion and support portion in the collapsed position; operating the attachment mechanism to connect the decorative and support portions together; and connecting the molding to the vehicle surface using the engagement members. The method may further include positioning at least one tension rib between and the decorative portion and the support portion such that the tension rib contacts both portions in the collapsed position. The method may further include the step of positioning at least one insert member through at least one opening on the decorative portion when the decorative portion and the support portion are in the collapsed position. The insert may include at least one of extruded plastic, chromed metal inserts, company logos, illuminated decals, and light emitting diodes and be attached to the support portion by at least one of friction, double-sided tape, and glue. The method may further include the step of forming at least one cutout on the support portion. The connecting step further may include applying tape and/or an adhesive between the support portion and the surface of the vehicle. At least one of the decorative portion and the support portion may have a thickness of about 1.8 mm to about 2.5 mm. The molding may be attached to an outer surface of the vehicle, or to one of a cladding near the rear door license plate illumination strips, cowl, incorporating seal, spray nozzle body, capturing hose assembly, radiator grill, pillar cover, rocker panel, seat assembly cover, side panel, interior organizer, and door panel of a vehicle.

Exemplary embodiments of the invention include the use of relatively thin wallstock, one or more cut-outs, and/or one or more stiffening and tension ribs. For example, in one aspect of the invention, wall thickness may be about 2.5 mm or less, depending on the type of material (or types of materials) used. Variations of the two-piece vehicle molding provided by the invention may include mold-in-color, grained, unpainted, or painted-in-color. The trim may include cut-outs through which a decorative insert affixed to the bearer can be displayed when the elements of the body side molding are snapped together. The decorative insert may be an extruded plastic insert that is painted or coated with a chrome-film or other film. Other variations are possible that may incorporate company logos, decals of every kind, illuminated decals, or even light emitting diodes (LEDs) as turn signals or decorations. In this manner, different body side molding styles, or an upgrade look, can be inexpensively achieved. An in-die draw process may be used to form stiffening ribs and/or tension ribs on (or to support) the backside (e.g., non-visible side) of the trim piece.

In one aspect, the bearer may be configured to accommodate all types of clip designs, and the positions occupied by the clips can be freely chosen. Additionally, the clips may be positioned at all (or virtually all) edges, thereby rendering unnecessary use of top edge tape strips and/or end die cuts. The bearer may also incorporate molded-on sealing lips formed using a two-shot molding process (polypropylene (PP) and thermoplastic elastomer (TPE)). This permits simplified placement and actuation of required mold actions.

In another aspect, the invention may provide narrower tape surfaces than those commonly used in conventional designs. The tape surfaces of the invention can be made solid and flat because they are formed on the bearer piece where readthroughs are not a concern. The solid and flat tape surfaces of the invention may be narrow because tape generally adheres better to smooth flat surfaces than it does to ribbed surfaces, and thus a smooth, solid tape land may have less surface area than a ribbed tape land.

According to yet another aspect of the invention, a method is provided for manufacturing a molded vehicle part adapted to be clippedly and/or adhesively affixed to a support surface. The method may include providing a single mold capable of producing an entire plastic vehicle part having foldable components. The plastic vehicle part may have a trim piece (“trim”) and a bearer piece (“bearer”). The trim and the bearer may each have a longitudinal axis, top and bottom edges, front and back ends, and opposing surfaces. The trim may include a snap ridge, which may preferably be formed along an edge of the trim, and may be constructed to include a channel between an inner surface of the trim and a portion of the snap ridge. The channel may be dimensioned such that it receives a portion of an edge of the bearer when the bearer is folded to adjoin an interior portion of the trim.

The bearer may be dimensioned and configured to (non-visibly) couple to the rear surface of the trim when folded to be adjacent thereto, and the snap ridge may be configured to securely hold both the trim and the bearer together in the closed position. The molded vehicle part may also include a foldable hinge that connects trim and the bearer. The hinge may be molded in the same mold simultaneously with the trim and bearer. Once cured, the hinge can preferably be folded without breaking.

A method of forming one embodiment of the hinged, two-piece molding of the invention may proceed as follows. A mold containing areas for forming at least the trim, the bearer, and the living hinge is provided. The mold may be injected with a liquefied plastic, thermoplastic, polymeric, resin, metal, or other suitable moldable material, and then cooled to harden the injected material. Prior to cooling, one or more mold actions (e.g. actuated movement of lifters within the mold) may be performed to create various features on the first body and/or second body. Examples of such features include, but are not limited to, the snap ridge, tension ribs, stiffening ribs, and/or clips previously described.

Once the injected material has sufficiently cured, the molding may be removed from the mold and is ready for use, except possibly for washing, painting, and/or similar finishing, if desired. If the molding is washed, any fluid trapped between any spaced projections of the first body, second body, and/or living hinge may be removed via draining, air drying, and/or heating before any finishing treatments are performed. Exemplary finishing treatments may include, but are not limited to, painting, forming one or more cut-outs, and/or attaching a decorative insert to the bearer and/or trim.

Thereafter, the finished two-piece molding may be folded about the living hinge as described above and readily connected to a support surface of a vehicle or other part, with or without a supplemental adhesive connection. The support surface may be an interior or exterior surface, which is typically made of sheet metal, glass, plastic, or similar materials. Exemplary support surfaces include, but are not limited to, vehicle claddings, rear door license plate illumination strips, cowls incorporating seals, spray nozzle bodies, capturing hose assemblies, radiator grilles, pillar covers, rocker panels, seat assembly covers, side panels, interior organizers, and door handles.

Additionally, a vehicle molding constructed according to the principles of the invention may have a thinner wall thickness than conventional vehicle moldings, and may permit use of an in-die process that forms film gates (areas where melted material enters the mold) directly on one or more parts of the vehicle molding such as the living hinge and/or the bearer. Such a vehicle molding may thus afford several advantages over conventional vehicle moldings.

For example, conventional vehicle moldings have film gates that are formed outside the part(s) and then trimmed off. This increases costs and manufacturing time. In contrast, a vehicle molding constructed according to the principles of the invention may form one or more film gates within a particular part (or parts) of the vehicle molding. Configuring the film gates within one or more parts of the vehicle molding eliminates the need to trim the film gates after the parts are formed.

Moreover, the wall thickness of conventional vehicle moldings is typically limited to about 3 mm to about 4 mm thick so that sink marks from the molded tape lands, and/or clips pockets will not read through to a visible surface of the vehicle molding. In contrast, the improved vehicle molding of the invention may have a wall thickness of between about 2 mm to about 2.5 mm thick. This makes the vehicle molding of the invention thinner and therefore lighter and enables it to cool off and cure faster during the molding cycle than conventional vehicle moldings. Additionally, the vehicle molding of the invention may be formed using “high-flow” materials that average about 1.8 mm to about 2.0 mm thick.

As another example, conventional methods form additional features, such as clips, directly onto the trim piece. Such methods, however, are complicated and require many mold actions (actuated movement of lifters within the mold). Moreover, small lifters tend to get hot during use, since they often are too small to place cooling lines in them. If the temperature rises too much, the excess heat can also cause readthroughs and even distortions. In contrast, embodiments of the invention may provide an improved manufacturing process that uses molds shallower than conventional designs, that uses large lifters, which allow water-cooling, and that requires a minimum number of mold actions. For example, the invention may require only about one inch of ejector travel as compared with about six to eight inches of ejector travel for conventional designs. These and other improvements provided by the invention lower cost, reduce complexity, permit creation of a lightweight and shallow mold, improve cycle times, shorten curing/cooling times, and lighten the weight of the finished vehicle molding.

Any of various types of adhesive materials known to a skilled artisan, including glues or types of double-sided adhesive tape custom-made or commercially available from a manufacturer such as 3M Corporation, have been used, provided the adhesive material has sufficient material characteristics (UV resistance, desired working and curing times, etc.) and sufficient adhesion to permanently adhere the molding to an exterior or interior surface of a vehicle. Thus, types of adhesive material may include liquid and semi-liquid (e.g., viscous) materials. The double-sided tape referenced above may include an adhesive material that is applied to opposite sides of a carrier material.

Embodiments of the invention will work equally well with virtually any type of molded part, whether formed of plastic, thermoplastic, polymer, resin, metal, or other moldable material. While the invention was developed to improve the attachment and design of vehicle moldings, the skilled artisan will recognize that the invention may be used in any number of applications or environments, particularly where plastic parts are to be attached adhesively to sheet metal, glass, plastic, or similar surfaces. Thus, the molding of the invention may also advantageously be used in non-automotive applications, particularly where there are concerns about readthrough, such as structural members, panels, and doors for low cost furniture.

Additional features, advantages, and embodiments of the invention may be set forth in the following detailed description, drawings, and claims, including methods of using the invention to reduce paint defects and/or to increase adhesion forces. Although numerous implementations and examples of the invention are set forth in the patent including in this “Summary of Invention” section, the examples and implementations are not intended to limit the scope of the invention.

### BRIEF DESCRIPTION OF THE DRAWINGS

The accompanying schematic drawings, which are included to provide a further understanding of the invention and are incorporated in and constitute part of this specification, illustrate embodiments of the invention and together with the detailed description, serve to explain principles of the invention. No attempt is made to show structural details of the invention in more detail than may be necessary for a fundamental understanding of the invention and the various ways in which it may be practiced. In the drawings:

FIG. 1 is a perspective view showing body side moldings attached to the door and quarter panel portions of a vehicle;

FIG. 2 is a cross-sectional view of a conventional body side molding adhesively affixed to a support surface;

FIG. 3 is an end view of a first embodiment of a body side molding constructed according to the principles of the invention shown in a first open position with a trim piece connected to a bearer piece by a living hinge;

FIG. 4 is an enlarged end view of the area “A” in FIG. 3, showing the living hinge of the invention in more detail;

FIG. 5 is a perspective view of the body molding of FIG. 3 shown in the open position;

FIG. 6A is a left end view of the body molding of FIG. 5;

FIG. 6B is a right end view of the body molding of FIG. 5 after the bearer piece has been folded about the living hinge and snapped into place within the trim piece;

FIG. 7 is a top plan view of the body molding of FIG. 5;

FIG. 8 is a bottom plan view of the body molding of FIG. 5;

FIG. 9 is an end view of a second embodiment of another body side molding constructed according to the principles of the invention shown in a first open position in which the trim piece has a cut-out and the bearer piece has an insert;

FIG. 10 is a perspective view of the body molding of FIG. 5 shown in the open position;

FIG. 11A is a left end view of the body molding of FIG. 10;

FIG. 11B is a right end view of the body molding of FIG. 10 after the bearer piece has been folded about the living hinge and snapped into place within the trim piece;

FIG. 12 is a top plan view of the body molding of FIG. 10; and

FIG. 13 is a bottom plan view of the body molding of FIG. 10.

### DETAILED DESCRIPTION OF EMBODIMENTS OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law.

Moreover, it is noted that like reference numerals represent similar parts throughout the several views of the drawings. It is understood that the invention is not limited to the particular methodology, protocols, devices, apparatus, materials, and reagents, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise. Thus, for example, a reference to “a molding” is a reference to one or more moldings and equivalents thereof known to those skilled in the art and so forth.

Moreover, provided immediately below is a “Definition” section, where certain terms to the invention are defined specifically for clarity and consistent with the broadest meaning that would be attributed to these terms by an ordinarily skilled artisan. Particular methods, devices, and materials are described, although any method and materials or equivalents to those described herein may be used in the practice or testing of the invention. All references cited herein are incorporated by reference herein in their entirety. Words not specifically defined are to be accorded the definition as would be understood by a person skilled in the art consistent with the specification.

Definitions

As used throughout the specification and claims, the terms “body molding” and/or “body side molding” encompass any molded plastic part capable of being attached to any interior or exterior surface of a vehicle.

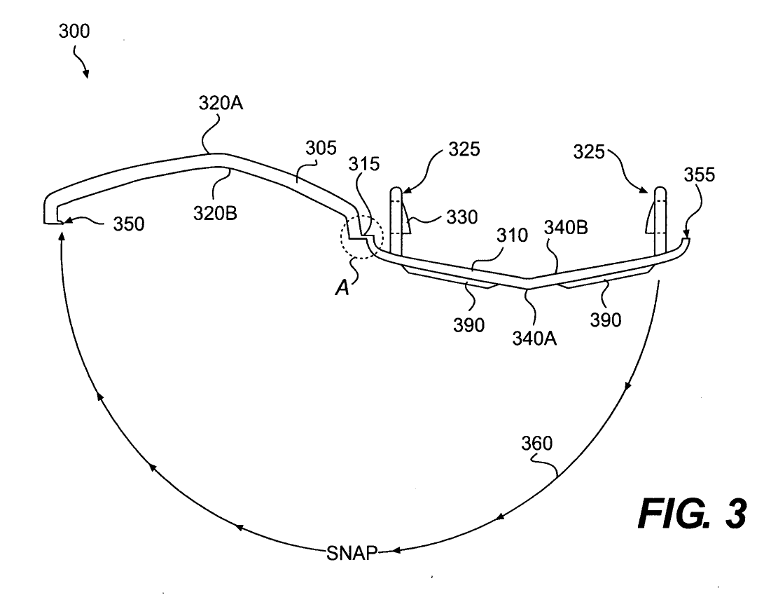

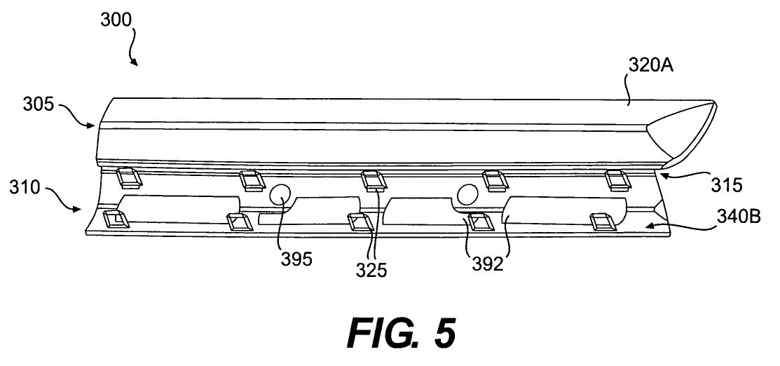

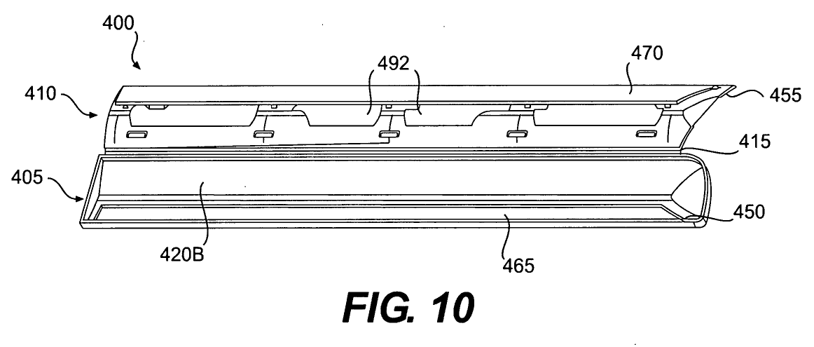

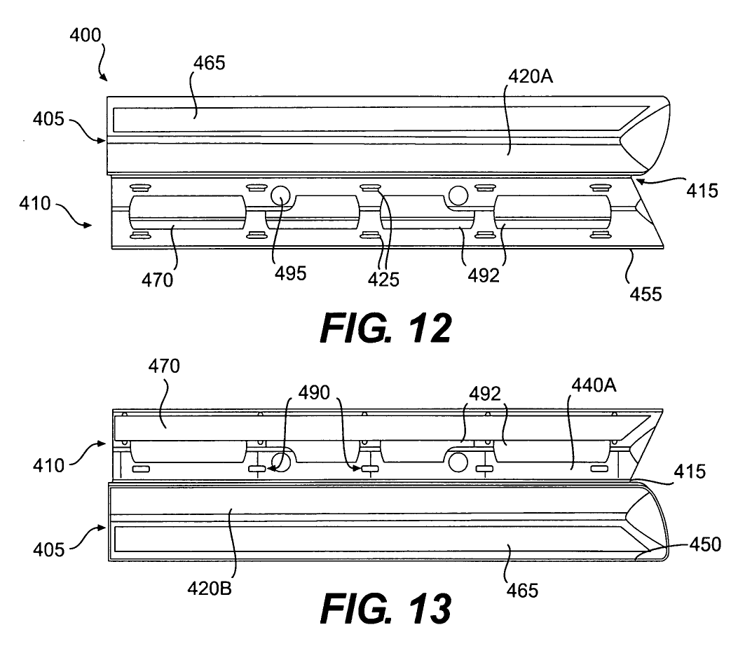

In describing FIGS. 3, 4, 5, 6, 7A, 7B, 8, 9, 10, 11A, 11B, 12, and 13, the phrases “outer surface” and “inner surface” may be used when referencing either the trim 305, 405 or the bearer 310, 410. As used herein, “outer surface” may include the surface of the body molding (or a part thereof) that would be furthest away from a support surface if the body molding were installed thereon. Similarly, “inner surface” may include the surface of the body molding (or a part thereof) that would be closest to the support surface if the body molding were installed thereon.

The term “readthrough” as used herein refers to a known phenomenon that occurs when a molded plastic part has solid areas of substantially different thickness, including sink marks and other visible imperfections or defects in the surface of the molded plastic part.

The term “relatively uniform thickness” as used herein with reference to a molding means that the molding has substantially the same thickness along its width or length, which thickness may vary gradually or due to manufacturing tolerances, but which does not include any regions of greatly varying thickness that cause a discontinuity in the thickness of the molding, such as a large projection or protuberance.

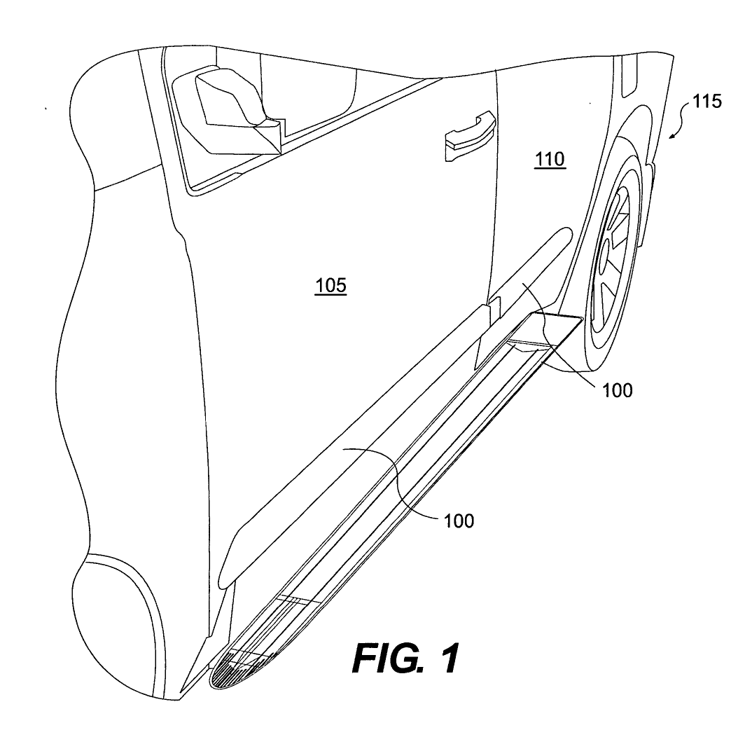

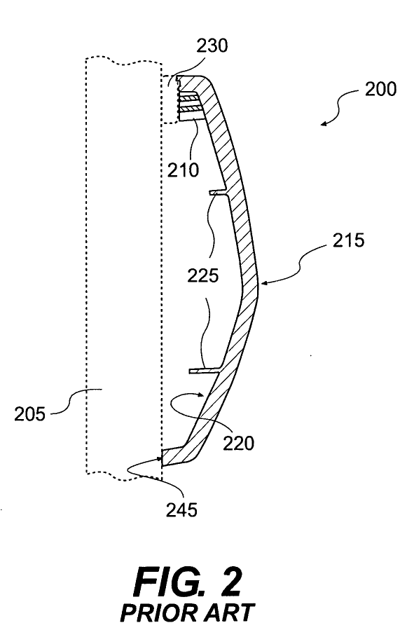

FIG. 1 is a perspective view of a plastic body side molding 100 showing its intended use attached to the door 105 and quarter panel 110 of a vehicle 115 to provide protection and/or a visually pleasing appearance for the body of the vehicle. The molding 100 may be attached to other parts or at in positions on the vehicle, as would be recognized by a skilled artisan. The types of vehicles to which the moldings of the invention may be attached include cars, trucks, SUVs, recreational vehicles and other types of motorized or non-motorized devices in which protection against dinging, scrapes, and damage to the exterior finish of the device is desired. Thus, while the invention is particularly adapted to attach protective body moldings to the sheet metal, glass, or plastic surfaces of vehicles, it may be applicable for any use in which a plastic part needs to be attached to these or similar materials.

While FIG. 1 shows that the body molding 100 may be adhered to an exterior side surface of a vehicle, the skilled artisan will appreciate that body moldings constructed according to the principles of the invention may be placed on other interior or exterior locations of the vehicle, and that the invention may be embodied in other interior or exterior plastic parts besides side moldings, as discussed in more detail below.

Referring to FIGS. 3, 5, 6A, 6B, 7, and 8, the trim 305, which may be the only part visible when the body molding 300 is affixed to a support surface, may include a convex outer “A” surface 320A and a concave inner surface 320B. A snap ridge 350 may be formed by a mold action (e.g., an actuated movement of a lifter within the mold), along a one edge of the inner surface 320B, and a living hinge 315 may be integrally formed between the trim 305 and bearer 310, e.g., hinge 315 may be formed along a spaced, opposing substantially parallel edge of the inner surface 320B. Illustratively, if the body molding 300 is to be substantially horizontally affixed to a support surface (not shown), the body molding 300 may be oriented such that the edge along which the snap ridge 350 is positioned is on the bottom, and the edge containing the living hinge 315 is on the top. Positioning the body molding 300 in this manner allows the folded living hinge 315 to shield the interior of the body molding 300 from water and other contaminants and also presents a pleasing aesthetic appearance.

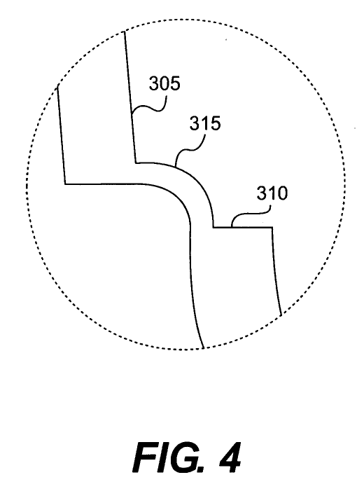

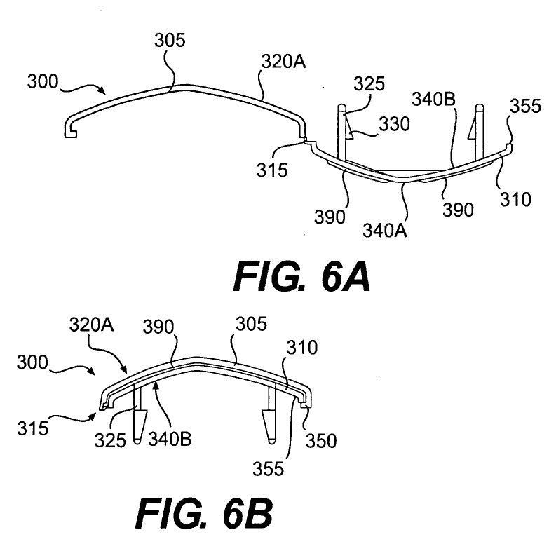

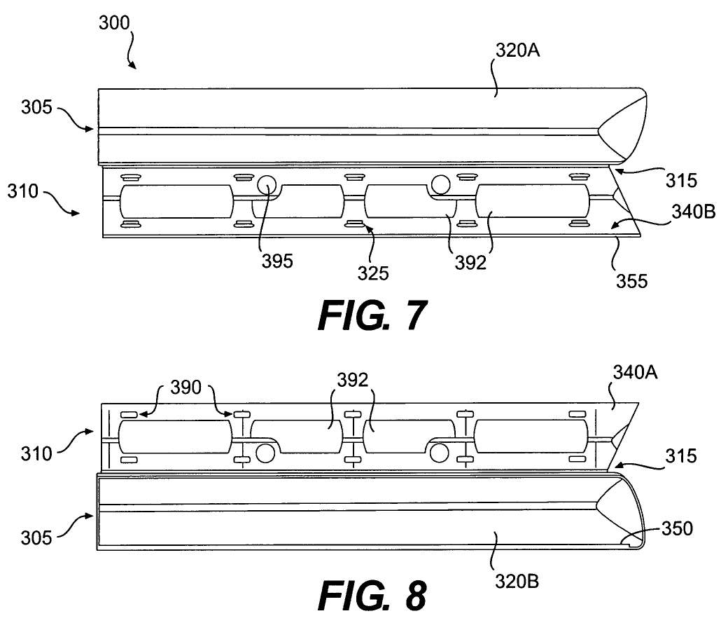

The living hinge 315 may formed such that it does not break when folded, since it is desirable that the living hinge stay together to provide structural support to the bearer 310. FIG. 4 is an exploded view of the living hinge 315 of FIG. 3 that illustrates the living hinge 315 bending as the bearer 310 is rotated towards the trim 305. Additionally, the living hinge 315 may also serve as a film gate for the trim 305 and as a connection for the trim 305 and bearer 310. As shown in FIG. 7, one or more additional film gates 395 may also be formed on the bearer 310 itself. When the bearer 310 is snapped into the trim 305, the living hinge 315 and/or or the bearer 310 may be concealed behind the trim 305, as shown in FIG. 6B.

The snap ridge 350 may be incorporated at the edge of the bearer 310. The snap ridge 350 may also be uninterrupted along the entire length of the bearer 310 or it may be interrupted in sections. The snap ridge 350 does not leave sink marks since it is large and solid over the length of the body molding 300. Cooling lines may also be added to prevent overheating of the snap ridge 350, which prevents possible waviness of the visible surface.

The bearer 310 preferably is not visible from the outside, and may include a convex outer surface 340A and a concave inner surface 340B. One or more (torsion) clips 325 may be molded on the inner surface 340B. Each clip may include a barb (or annular projection) 330. The clips 325 are designed to engage into corresponding clip receptacles (not shown) formed in the support surface as is known in the art. Any clip design known to one of skill in the art may be incorporated into the bearer. Clips 325 may also be formed on the support surface and clip receptacles could be formed on the bearer 310. In addition, clips 325 may be molded close to the edges of the bearer, or any position along the bearer 310. Additionally, one or more tape lands and/or torsion clips 325 may be formed along an edge of the bearer 310 to adhere the body molding 300 to a support surface. Narrow strips of tape may be used on the bearer 310 since tape adheres solidly to the taping surfaces, thus reducing cost.

Referring to FIGS. 3 and 8, the bearer 310 may be stiffened with one or more tension ribs 390 that are formed on the outside surface 340A of the bearer 310. When the free edge 355 of the bearer 310 snaps past the snap ridge 350, the one or more tension ribs 390 compress (deform), and thereby prevent rattling, between the two parts as discussed below.

Referring to FIGS. 3, 7 and 8, cut-outs 392 (FIGS. 7 and 8) may be formed in bearer 310 to remove as much weight as possible. Use of cutouts 392 is possible since tension ribs 390 (FIG. 3) are included on the bearer 310 to provide the requisite structural support. Each tension rib 390 may be a thin piece of deformable plastic. When the body molding 300 is formed, each tension rib 390 projects upwardly from the arm to the surface 340A of the bearer 310. Each tension rib 390, however, deforms under pressure when the bearer 310 engages the snap ridge 350. In this manner each deformed tension rib 390 strengthens the body molding 300 and keeps the bearer 310 from vibrating against the trim 305.

Using cut-outs 392, it is possible, given current design limitations, to produce a body molding 300 that weighs less than conventional body moldings of comparable size and/or quality. For example, an improved body molding 300 that includes bearer 310 and trim 305 may weigh approximately 165 grams versus about 175 grams to about 180 grams for a conventional body molding.

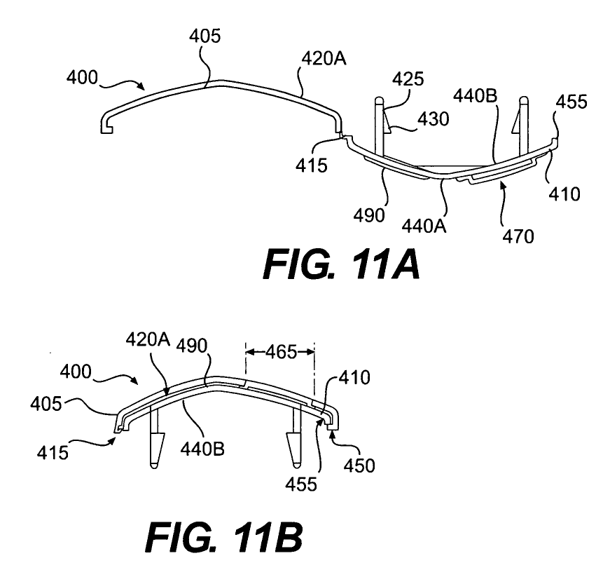

Although the trim 305, living hinge 315, and bearer 310 are preferably formed in a single mold, the trim 305 and bearer 310 are formed such that they each face opposite directions. That is, the concave surface 320B of the trim 305 faces one direction, while the concave face 340B of the bearer 310 faces the opposite direction. Consequently, when the bearer 310 is rotated in the direction indicated by the arrowed line 360 (e.g., towards the trim 305), the tension rib 390 formed on the convex outer surface 340A of the bearer 310 contacts the concave inner surface 320B of the trim 305. Additionally, the free end 355 of the bearer 310 engages the snap ridge 350 formed on the trim 305. This relationship is shown more clearly shown in FIGS. 6B and 11B. Once the bearer 355 is retained by the snap ridge 350, a firm connection may be established between the body molding 300 and a support surface.

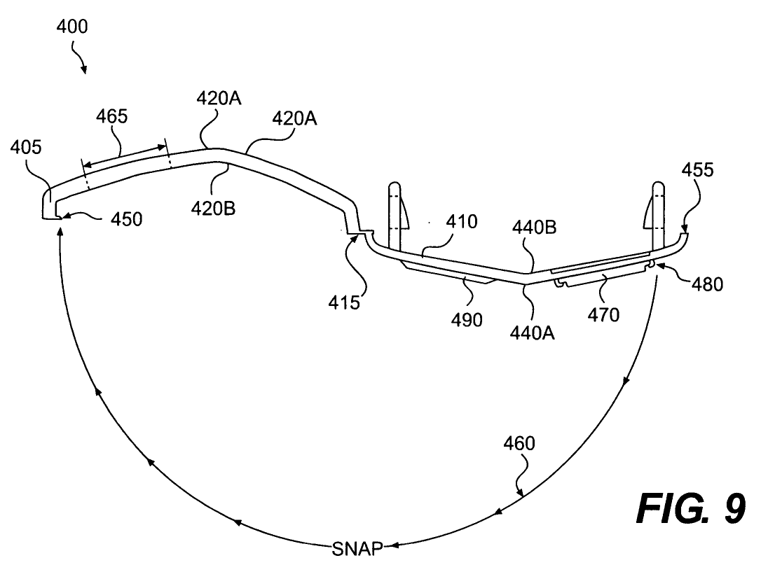

The body molding 400 depicted in FIGS. 9, 10, 11A, 11B, 12, and 13, includes a trim 405, a bearer 410, a living hinge 415, a trim outer surface 420A, a trim inner surface 420B, clips 425, barbs 430, a bearer outer surface 440A, a bearer inner surface 440B, a snap ridge 450, a bearer edge 455, one or more tension ribs 490, one or more cutouts 492, and one or more film gates 495. At least the trim 405, the living hinge 415, and the bearer 410 are preferably formed in a single mold. Each feature of the body molding 400 is constructed and functions similar to the corresponding parts of the body molding 300 described above. Thus, for example, the bearer 410 may be moved in the direction of arrowed line 460) to rotate (or bend) about the living hinge 415 until the bearer's free end 455 engages the snap ridge 450. When the free edge 455 of the bearer 410 snaps past the snap ridge 450, the one or more tension ribs 490 compress (deform), to prevent the trim from rattling against the bearer.

The body molding 400 differs from the body molding 300 in that the body molding 400 includes an opening 465 in the “A” surface of the trim 405. The opening 465 is configured such that an insert 470 attached to the bearer 410 becomes visible through the opening 465 when the bearer 410 and trim 405 are snapped together. By designing the body molding 400 with relatively large open sections 465, different styles or upgrade looks can be achieved. Thus, the insert 470 may be mounted such that its visible top surface may be flush with a portion of the visible surface of the trim 405, such as shown in FIG. 11B, or uneven. The insert may be painted or molded to match the body color of the vehicle. Additionally, the insert 470 may be formed of extruded plastic, which may be co-extruded with a chrome effect film or a paint film. Skilled artisans will appreciate that the insert 470 is not limited to extruded plastic, but may also include at least chromed metal inserts, company logos, illuminated and non-illuminated decals, or even LED's that may serve as turn or other traffic signals or decorations.

Various attachment means known to skilled artisans may be used to detachably or permanently attach the insert 470 to the bearer 410. For example, the insert 470 may be held in place only by friction and/or pressure created when the bearer 410 occupies the closed position shown in FIG. 11B. Use of the bearer 410 and the cutout 465 to secure the insert 470 reduces and/or prevents warping and renders taping unnecessary. In another embodiment, however, the insert 470 could also be secured to the bearer 410 using double-sided tape, glue, or other attachment means known to a skilled artisan.

The invention also provides a method for constructing moldings. The method may include one or more of the following steps, performed in any suitable order: preparing and configuring an injection mold to form a trim and a bearer connected by a living hinge; filling the injection mold with a moldable material; performing a minimum mold action to form a component on at least one of the trim, the living hinge, and the bearer; curing the moldable material; and removing the integrally molded trim, living hinge, and bearer from the mold. The injection molded part is now ready to be used as a molding. If desired, finishing steps such as washing, drying, and/or painting at least one of the trim, the living hinge, and the bearer may be performed to achieve desired aesthetic effects.

The molding and similar plastic parts of the invention may be molded using any suitable process or technique known to persons of ordinary skill in the art; however, injection molding is preferred. Injection molding may include, but is not limited to, compression injection molding, gas assist injection molding, water assist injection molding, gas counter-pressure injection molding, reaction injection molding (RIM) and other types of injection molding techniques known in the art. Other exemplary molding techniques currently available include, but are not limited to blow molding, compression molding, and rotary molding. Extrusion molding is not desirable because extruded parts require further processing to obtain a finished product and may require end caps, for example, to produce smooth edges.

Polypropylene is a preferred material that may be used to form the molding of the invention, but other exemplary materials may include, but are not limited to thermoplastic polyolefins (TPO), acrylonitrate-butadiene-styrene (ABS), polycarbonate (PC), polybutadiene terephthalate (PBT), polyethylene terephthalate (PET), nylon, polyvinyl chloride (PVC), polystyrene (PS), polyethylene (PPE), thermoplastic polyolefin (TPO), and blends of the above materials with other suitable materials. For example, polypropylene may be modified with synthetic rubber, glass, etc.

The step of preparing an injection mold may further include preparing the mold to form one or more cut-outs in the bearer. In addition, preparing an injection mold may include preparing the mold to form one or more tension ribs and/or one or more clips on the bearer. It may also include preparing the mold to form one or more openings in the trim through which an insert may be displayed when the bearer is snapped into the trim. Preferably, all of the features of a given molding such as the trim, the living hinge, the snap ridge, the bearer, the torsion clip(s), and/or the tape land(s) are formed in the same manufacturing process, preferably an injection molding process that produces a clean, finished, and ready to use part.

Separate formation and attachment of these and/or other features, however, is possible. All clips, stiffening ribs, and tension ribs may be molded by a die-draw process. In addition, a snap ridge may be incorporated by molding it onto the bearer using a 2-shot molding (PP+TPE) process.

The invention also provides a method for assembling moldings. The method may include at least the following steps, performed in any suitable order: moving the bearer toward the interior of the trim; and engaging a portion of the bearer with a corresponding snap ridge formed on the trim. The method of assembly may further include positioning an insert on (or proximate) a portion of the bearer such that the insert aligns with an opening formed in the trim, moving the bearer toward the interior of the trim; and engaging a portion of the bearer with a corresponding snap ridge formed on the trim.

The invention also provides a method for installing moldings. This method may include one or more of the following steps, performed in any suitable order: providing an assembled molding having a bearer snapped within a trim; aligning one or more torsion clips formed on a bottom surface of a bearer with one or more corresponding clip receptacles formed on a support surface; and applying pressure to the molding to engage each torsion clip within its corresponding clip receptacle. This method may also include the step of applying an adhesive to one or more portions of the molding.

While the invention is particularly suited for use on a vehicle body side panel, it may also be used in other inner or outer parts of a vehicle, including use as claddings such as near the rear door license plate illumination strips (LPIs, also called eyebrows), cowls, incorporating seals, spray nozzle bodies, capturing hose assemblies, radiator grilles, pillar covers, rocker panels, seat assembly covers, side panels, interior organizers and door panels. In addition, the molding of the invention may also be used in non-automotive applications such as structural members, panels, and doors for low cost furniture and other applications where readthrough is a concern.

Although the above descriptions are directed to various embodiments of the invention, other variations and modifications may be made without departing from the spirit and scope of the invention. For example, features described in connection with one embodiment of the invention may be used in conjunction with other embodiments, even if not explicitly stated above.

What is claimed is:

1. A vehicle molding for protecting a surface of a vehicle, said molding comprising:
a unitary injection molded piece having a decorative portion, a support portion, and a hinge disposed therebetween, said hinge having a thickness less than the thickness of at least one of said decorative and support portions to facilitate pivotal motion of said decorative and support portions relative to each other from a first expanded position in which said decorative and supportive portions are spaced apart to a second collapsed position in which said decorative and support portions are adjacent to each other;
said decorative portion being of relatively uniform thickness and having a decorative surface substantially free of readthrough;
an attachment mechanism to connect said decorative and support portions together in the collapsed position.

2. The molding of claim 1, wherein a portion of said decorative portion includes a first part and a portion of said support portion includes a second part that engages with said first part to form said attachment mechanism.

3. The molding of claim 2, wherein said first and second parts are integrally molded with said decorative and support portions.

4. The molding of claim 3, wherein said first part comprises a ridge and said second part comprises a lip engageable with said ridge to form a snap connection.

5. The molding of claim 1, wherein said decorative portion has a first shape and said support portion has a second shape that matingly corresponds to said first shape when said decorative portion and said support portion are in the collapsed position secured together by said attachment mechanism.

6. The molding of claim 5, wherein one of said first and second shapes is convex, and the other is concave such that said decorative portion and said support portion are nested together in the collapsed position.

7. The molding of claim 1, wherein said support portion includes at least one engagement member integrally formed therewith to connect the molding to the surface of the vehicle.

8. The molding of claim 1, further comprising at least one tension rib disposed between and contacting said decorative portion and said support portion in the collapsed position.

9. The molding of claim 7, wherein said at least one tension rib is integrally formed with one of said decorative portion and support portion.

10. The molding of claim 9, wherein said at least one tension rib comprises a thin piece of deformable plastic.

11. The molding of claim 1, wherein said support portion includes at least one insert and said decorative portion includes at least one opening such that said at least one insert fits through said at least one opening when said decorative portion and said support portion are in the collapsed position.

12. The molding of claim 11, wherein said at least one insert includes at least one of extruded plastic, chromed metal inserts, company logos, illuminated decals, and light emitting diodes.

13. The molding of claim 12, wherein said at least one insert is attached to said support portion by at least one of friction, double-sided tape, and glue.

14. The molding of claim 1, wherein said support portion includes at least one cutout.

15. The molding of claim 1, wherein said support portion includes at least one substantially flat surface so that tape and/or an adhesive may be applied to connect the molding to the surface of the vehicle.

16. The molding of claim 1, where said at least one of said decorative portion and said support portion has a thickness of about 1.8 mm to about 2.5 mm.

17. The molding of claim 1, wherein said molding is a body molding to protect an outer surface of the vehicle.

18. The molding of claim 1, wherein said molding is attached to one of a cladding near the rear door license plate illumination strips, cowl, incorporating seal, spray nozzle body, capturing hose assembly, radiator grill, pillar cover, rocker panel, seat assembly cover, side panel, interior organizer, and door panel of a vehicle.

19. A method of making a vehicle molding having a decorative portion and a support portion connected by a hinge using injection molding, said method comprising:
providing a single mold to form the decorative portion, the support portion, and the hinge;
filling the mold with a moldable material;
integrally injection molding the decorative portion, the support portion, and the hinge in the single mold from the moldable material such that the hinge has a thickness less than the thickness of at least one of said decorative and support portions to facilitate pivotal motion of the decorative and support portions and the decorative portion is substantially free of readthrough;
curing the moldable material; and
removing the molding from the mold.

20. The method of claim 19, further comprising the step of integrally forming one or more engagement members on the support portion during the injection molding step.

21. The method of claim 19, further comprising the step of integrally forming one or more tension ribs on at least one of the support portion and the decorative portion, such that the tension ribs are disposable between and may contact the support and decorative portions during use.

22. The method of claim 19, further comprising the step of forming one or more openings in one of the decorative portion and the support portion.

23. The method of claim 22, further comprising the step of inserting one or more decorative or functional members through the one or more openings.

24. The method of claim 19, wherein said integrally injection molding step comprises one or more of compression injection molding, gas assist injection molding, water assist injection molding, gas counter-pressure injection molding, and reaction injection molding (RIM).

25. The method of claim 19, wherein the molding material comprises one or more materials selected from the group consisting of thermoplastic polyolefins, acrylonitrate-butadiene-styrene, polycarbonate, polybutadiene terephthalate, polyethylene terephthalate, nylon, polyvinyl chloride, polystyrene, polypropylene, polyethylene, thermoplastic polyolefin, synthetic rubber, glass, or blends thereof.

26. The method of claim 19, wherein at least one of the decorative portion and the support portion has a thickness of between about 1.8 mm to about 2.5 mm.

27. The method of claim 19, further comprising one or more finishing steps of washing, drying, and painting at least one of the decorative portion, the support portion, and the hinge.

28. The method of claim 19, wherein said injection molding step includes forming at least one film gate on at least one of the support portion and the hinge.

29. A method of attaching a molding to a surface of a vehicle, said method comprising:
providing a unitary injection molded part having a decorative portion and a support portion connected by a hinge having a thickness less than the thickness of at least one of the decorative and support portions to facilitate pivotal motion of the decorative and support portions relative to each other from a first expanded position in which the decorative and supportive portions are spaced apart to a second collapsed position in which the decorative and support portions are adjacent to each other, the decorative portion being of relatively uniform thickness and having a decorative surface substantially free of readthrough, the support portion including engagement members to connect the molding to the surface of the vehicle, and an attachment mechanism to connect the decorative and support portions together in the collapsed position;
positioning the decorative portion and support portion in the collapsed position;
operating the attachment mechanism to connect the decorative and support portions together; and
connecting the molding to the vehicle surface using the engagement members.

30. The method of claim 29, further comprising the step of positioning at least one tension rib between and the decorative portion and the support portion such that the tension rib contacts both portions in the collapsed position.

31. The method of claim 29, further comprising the step of positioning at least one insert member through at least one opening on the decorative portion when the decorative portion and the support portion are in the collapsed position.

32. The method of claim 31, wherein the at least one insert includes at least one of extruded plastic, chromed metal inserts, company logos, illuminated decals, and light emitting diodes.

33. The method of claim 31, wherein the at least one insert is attached to the support portion by at least one of friction, double-sided tape, and glue.

34. The method of claim 29, further comprising the step of forming at least one cutout on the support portion.

35. The method of claim 29, wherein said connecting step further comprises applying tape and/or an adhesive between the support portion and the surface of the vehicle.

36. The method of claim 29, where at least one of the decorative portion and the support portion has a thickness of about 1.8 mm to about 2.5 mm.

37. The method of claim 29, wherein said molding is attached to an outer surface of the vehicle.

38. The method of claim 29, wherein the molding is attached to one of a cladding near the rear door license plate illumination strips, cowl, incorporating seal, spray nozzle body, capturing hose assembly, radiator grill, pillar cover, rocker panel, seat assembly cover, side panel, interior organizer, and door panel of a vehicle.
